(19) United States
(12) Patent Application Publication
(10) Pub. No.: US 2025/0263029 A1
(43) Pub. Date: Aug. 21, 2025

(54) VEHICLE FENDER COVER STRUCTURE

(71) Applicant: SUBARU CORPORATION, Tokyo (JP)

(72) Inventor: Koji SHINOHE, Tokyo (JP)

(73) Assignee: SUBARU CORPORATION, Tokyo (JP)

(21) Appl. No.: 19/025,077

(22) Filed: Jan. 16, 2025

(30) Foreign Application Priority Data
Feb. 15, 2024 (JP) 2024-021302

(51) Int. Cl. B60R 13/08; B60R 13/06

(52) U.S. Cl. CPC B60R 13/0838; B60R 13/06

(57) ABSTRACT

A vehicle fender cover structure covering a gap above a vehicle body frame member of a vehicle includes a fender cover body, a sound insulation material, and a seal. The fender cover body includes a vertical plate covering the gap from an inner side in the vehicle widthwise direction, and a top plate projecting from an upper end of the vertical plate outward in the vehicle widthwise direction. The sound insulation material is provided along the vertical plate, and prevents noise from being released from the engine room to an outside of the vehicle. The seal is provided on the top plate, is brought into elastic contact with an inner side in the vehicle widthwise direction of an upper end part of an exterior member of the vehicle, and blocks a current of air gushing to the outside of the vehicle.

### CROSS-REFERENCE TO RELATED APPLICATIONS

The present application claims priority from Japanese Patent Application No. 2024-021302 filed on Feb. 15, 2024, the entire contents of which are hereby incorporated by reference.

### BACKGROUND OF THE INVENTION

### Field of the Invention

The present invention relates to a vehicle fender cover structure that covers a gap occurring between a vehicle body frame member, which forms an engine room, and a front fender panel.

### Description of Background Art

Japanese Unexamined Patent Application Publication (JP-A) No. 2009-161141 describes a fender cover (fender protector). The entire contents of this publication are incorporated herein by reference.

### SUMMARY OF THE INVENTION

According to one aspect of the present invention, a vehicle fender cover structure includes a fender cover body including a vertical plate, a sound insulation material that is positioned along a surface of the vertical plate and prevents noise from being released from an engine room of a vehicle to an outside of the vehicle, and a seal positioned on a top plate that tis projecting from an upper end of the vertical plate outward in a vehicle widthwise direction and is brought into elastic contact with an inner side in the vehicle widthwise direction of an upper end part of an exterior member of the vehicle and block a current of air gushing to the outside of the vehicle from the engine room. The vertical plate of the fender cover body covers the top plate and a gap above a vehicle body frame member of the vehicle on an outer side of the engine room in the vehicle widthwise direction from an inner side in the vehicle widthwise direction, and a hardness of a material of the fender cover body is greater than a hardness of a material of the sound insulation material.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a front perspective view illustrating a state in which fender covers are disposed on vehicle-widthwise outer sides of an engine room;

FIG. 2 is an enlarged front perspective view illustrating a state in which the fender cover is disposed on the vehicle-widthwise outer side of the engine room;

FIG. 3 is an enlarged front perspective view illustrating a structure of the fender cover in an exploded state;

FIG. 4 is a cross-sectional view along line IV-IV of FIG. 2;

FIG. 5 is a cross-sectional view along line V-V of FIG. 2;

FIG. 6 is a cross-sectional view along line VI-VI of FIG. 2; and

FIG. 7 is a cross-sectional view along line V-V of FIG. 2, illustrating a state in which noise is prevented from being released to the outside of a vehicle from the engine room and in which a current of air gushing from the engine room in the direction of a vehicle-widthwise outer side.

### DETAILED DESCRIPTION OF THE EMBODIMENTS

Embodiments will now be described with reference to the accompanying drawings, wherein like reference numerals designate corresponding or identical elements throughout the various drawings.

The term “join” used in the following description includes a joining method represented by fusion joining, structural joining, etc.

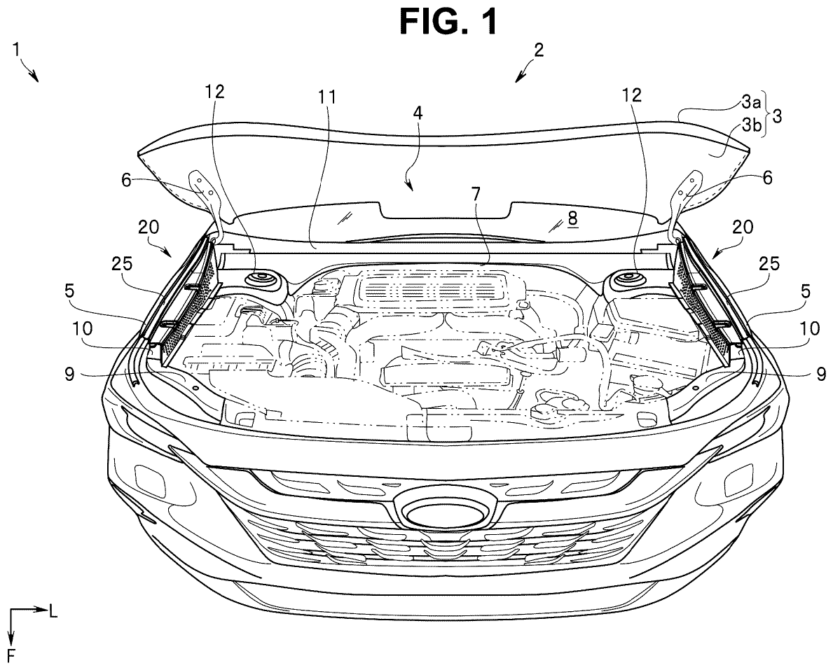

As illustrated in FIG. 1, the front part of a vehicle body 2 of a vehicle 1 includes an engine hood 3, an engine room 4, and a lateral pair of front fender panels 5.

The engine hood 3 includes, for example, an outer panel 3a and an inner panel 3b, each of which is composed of a steel plate. The outer panel 3a has its outer edges finished with a hemming process to reach the inner panel 3b. Both ends of the rear end part of the engine hood 3 are swingably supported by the vehicle body 2 via a lateral pair of hinges 6.

The engine room 4 has an upward-facing opening 7 that is connected to the inner part of the engine room 4.

The opening 7 can be opened and closed by the engine hood 3. This opening 7 is formed along frames of the vehicle body 2 surrounding the engine room 4.

The frames include, for example, a radiator core upper (not illustrated) extending in the vehicle-widthwise directions in front of the opening 7, a lateral pair of radiator core upper sides 9, and a lateral pair of apron upper members 10, as vehicle body frame members. These vehicle body frame members are formed by applying press work on a sheet metal member including a high-strength steel plate, etc.

The lateral pair of radiator core upper sides 9 extend with a curve from both ends of the radiator core upper toward the rear part of the vehicle body.

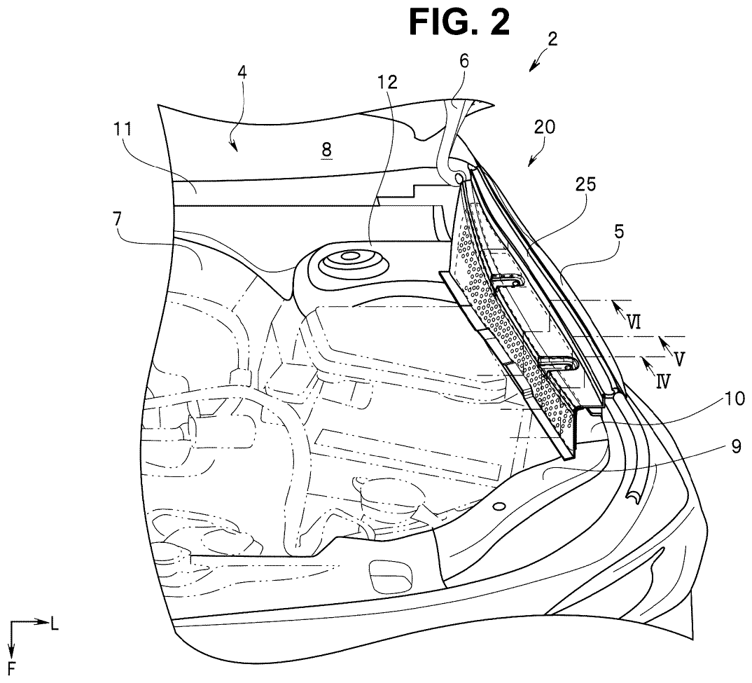

As illustrated in FIG. 1 through FIG. 3, the lateral pair of apron upper members 10 project from both ends of a cowl top 11, which extends in the vehicle-widthwise directions, toward the front of the vehicle body along the engine room 4 at the vehicle-widthwise-outer-side lower end parts of a front glass 8. The front end part of each of the apron upper members 10 projecting toward the front of the vehicle body is connected with the rear end part of its corresponding radiator core upper side 9. To the vehicle-widthwise inner side of each of the apron upper members 10, for example a suspension tower 12 supporting the upper part of a suspension device (not illustrated) is joined.

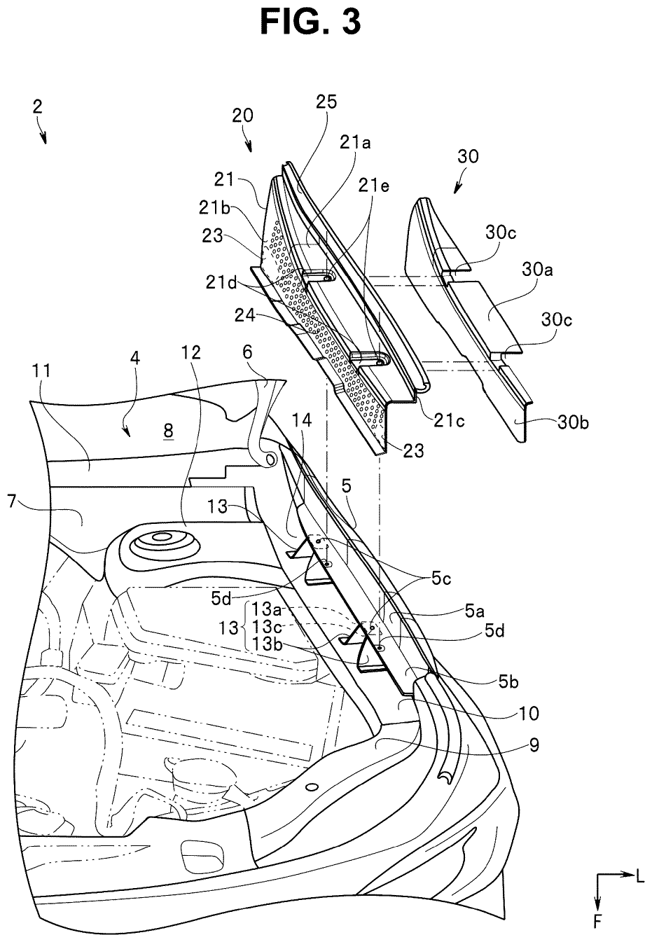

The upper surface of each of the apron upper members 10 has a longitudinal pair of brackets 13 as illustrated in FIG. 3. The brackets 13 are for attaching the front fender panels 5.

The longitudinal pair of brackets 13 have a prescribed interval between them for example in the longitudinal direction of the vehicle body. Each of the brackets 13 is formed by applying press work on a sheet metal member. Receiving this work, each of the brackets 13 has a substantially-hat-shaped cross section in a vehicle-widthwise side view.

Specifically, each of the brackets 13 includes a top plate 13a and a pair of walls 13b.

The top plates 13a are provided at positions opposite to the upper surfaces of the apron upper members 10 at prescribed intervals. The top plate 13a has, at its substantial center, a bolt-hole 13c for attaching the front fender panel 5.

The pair of walls 13b project downward from the ends of the top plate 13a that exist in the longitudinal direction of the vehicle body. The lower end part of each of the walls 13b projecting downward is joined to the upper surface of the apron upper member 10 while being bent in the longitudinal direction of the vehicle body.

Thus provided brackets 13 can absorb collision energy through collapse of their walls 13b for example when a collision load more than or equal to a prescribed value is applied from above the front fender panel 5.

As illustrated in FIG. 3, the lateral pair of front fender panels 5 are provided on vehicle-widthwise outer sides as exterior members of the vehicle body 2. Each of the front fender panels 5 is formed for example by applying press work on a sheet metal member including a steel plate, etc.

Each of the front fender panels 5 includes an inner wall 5a and a flange 5b.

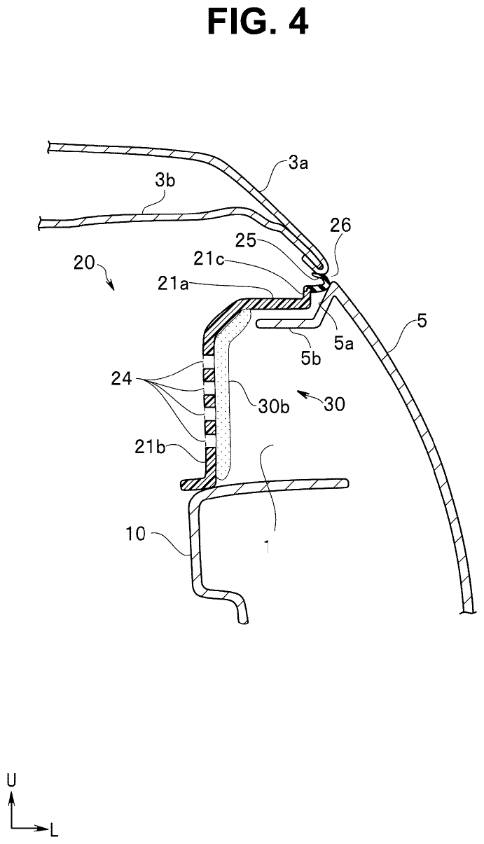

As illustrated in FIG. 4, the inner wall 5a projects downward for example from the edge of the upper end of the front fender panel 5. The inner wall 5a has a vehicle-widthwise inner surface that is substantially planar. This enables a seal 25, which will be described later, to be brought into elastic contact with the vehicle-widthwise inner surface of the inner wall 5a from the vehicle-widthwise inner side.

The flange 5b projects from the lower end parts of the inner wall 5a toward the vehicle-widthwise inner side. As illustrated in FIG. 3, this flange 5b has a bolt-hole 5c at a position corresponding to each of the bolt-holes 13c. The flange 5b also has a longitudinal pair of clipping holes 5d for attaching a fender cover 20, which will be described later.

The flange 5b abuts on each of the top plates 13a with the bolt-holes 5c aligned with their corresponding bolt-holds 13c from above.

The front fender panel 5 is thereby fastened to each of the brackets 13 with bolts (not illustrated) from above with the flange 5b abutting on the brackets 13. In other words, the front fender panel 5 has its upper portion attached to the apron upper member 10 via the brackets 13.

This structure with the brackets 13 between the front fender panel 5 and the apron upper member 10 results in a gap 14, equivalent to the height of each of the brackets 13, formed between the upper surface of the apron upper member 10 and the flange 5b as illustrated in FIG. 3.

To cover the gap 14 like this from the vehicle-widthwise inner side, the engine room 4 has a lateral pair of the fender covers 20 at each of its side portions.

The lateral pair of fender covers 20 and their peripheral portions are symmetrical in basic structure. Accordingly, explanations are hereinafter given to the left part of the vehicle body as an example.

As illustrated in FIG. 3, the fender cover 20 according to the present embodiment includes a fender cover body 21, the seal 25, and a sound absorption material 30.

Specifically, the fender cover body 21 includes a top plate 21a and a vertical plate 21b. The top plate 21a and the vertical plate 21b are formed as a single member out of for example a synthetic resin material such as a polypropylene (PP) material etc.

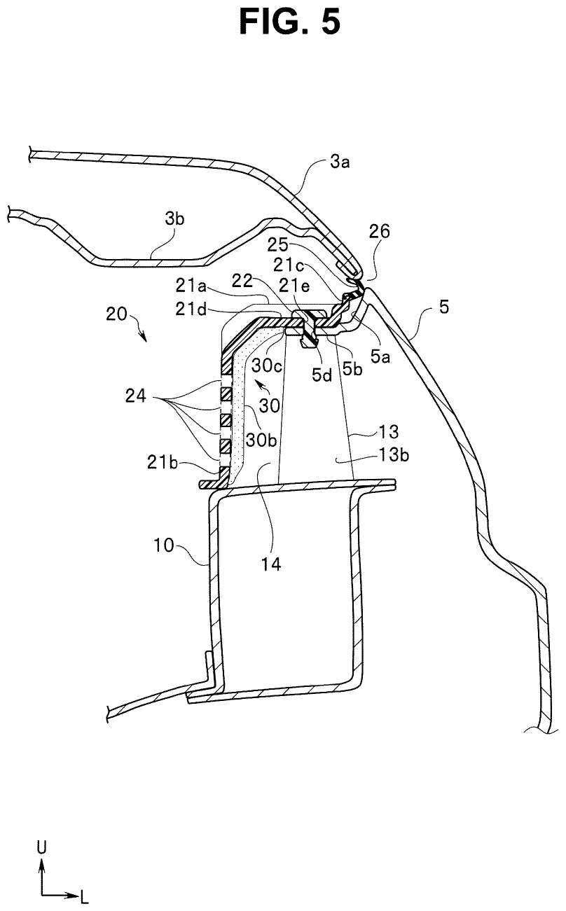

The top plate 21a is provided at a position opposite to the upper surface of the flange 5b. The top plate 21a further has, as illustrated in FIG. 3 and FIG. 5, an upward flange 21c and a longitudinal pair of step parts 21d.

The upward flange 21c projects upward from the vehicle-widthwise outer edge of the top plate 21a.

The longitudinal pair of step parts 21d have a prescribed interval between them for example in the longitudinal direction of the top plate 21a. Each of the step parts 21d has a shape projecting downward from the bottom of the top plate 21a in a vehicle-widthwise side view. This enables the bottom of each of the step parts 21d to abut on the upper surface of the flange 5b.

Each of these step parts 21d serves as a fixer for attaching the fender cover body 21 to the flange 5b. Thus, each of the step parts 21d has a clipping hole 21e.

The projection of each of the step parts 21d is formed to have a dimension equivalent to the thickness of the sound absorption material 30, which will be described later. This enables the sound absorption material 30 to be held at the gap between the top plate 21a and the flange 5b when the fender cover body 21 is attached to the flange 5b.

As illustrated in FIG. 3, each of the clipping holes 21e is provided at a position opposite to its corresponding one of the clipping holes 5d provided to the flange 5b. As illustrated in FIG. 5, each of the clipping holes 21e such as this can have a clip 22 inserted through it from above, while being aligned with its corresponding one of the clipping holes 5d.

With this insertion of the clip 22 through each of the clipping holes 21e, the fender cover body 21 is attached to the flange 5b.

As illustrated in FIG. 4 through FIG. 6, the vertical plate 21b is disposed from the vehicle-widthwise inner side at a position opposite to the gap 14. This vertical plate 21b projects downward from the vehicle-widthwise inner edges of the top plate 21a and each of the step parts 21d. In other words, the vertical plate 21b is positioned to cover the gap 14 from the vehicle-widthwise inner side. The lower end part of thus provided vertical plate 21b can abut, while being bent vehicle-widthwise inwardly, on the upper surface of the apron upper member 10.

As illustrated in FIG. 3, the vertical plate 21b has a longitudinal pair of welding areas 23 and holes 24. The longitudinal pair of welding areas 23 are for fixing the sound absorption material 30 through thermal welding.

The holes 24 are provided for example over the substantially entire surface of the vertical plate 21b, excluding the welding areas 23. Also, the holes 24 are provided at substantially regular intervals. Each of the holes 24 is substantially circular. Each of such holes 24 serves as a hole for transmitting noise from the engine room 4 to the front fender panel 5.

As illustrated in FIG. 3 through FIG. 6, the seal 25 is provided to the upper end part of the upward flange 21c of the top plate 21a. This seal 25 serves to seal a gap 26 between the upper end part of the front fender panel 5 and the vehicle-widthwise outer end of the engine hood 3.

The seal 25 is formed of an elastic member such as a rubber material, etc. The seal 25 such as this is for example permanently affixed to the upper end part of the upward flange 21c through 2-color molding.

Thus formed seal 25, while being elastically deformed, is brought into pressure contact with the upper end part of the inner wall 5a of the front fender panel 5 from the vehicle-widthwise inner side. The seal 25, while being elastically deformed, is also brought into pressure contact with the vehicle-widthwise outer end of the engine hood 3 from the vehicle-heightwise lower side, when the engine hood 3 is closed.

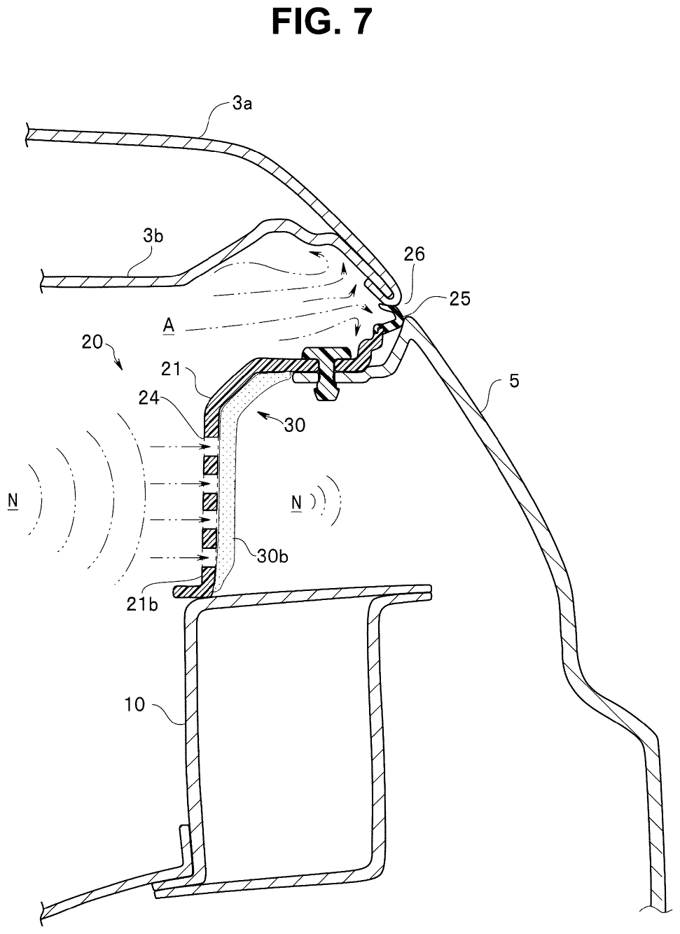

Through the elastic contact such as these, the seal 25 seals the gap 26. This enables the seal 25 to block a current of air A gushing from the engine room 4 (see FIG. 7). In order to adequately seal the gap 26 with the seal 25, conditions such as the shape, thickness, etc. of the seal 25 are beforehand obtained through experiments, simulations, etc.

The sound absorption material 30 is formed of for example a non-woven fabric etc. that can absorb noise from the engine room 4. As illustrated in FIG. 3 through FIG. 6, the sound absorption material 30 is provided along the inside of the open cross-section of the fender cover body 21 before the fender cover body 21 is attached to the front fender panel 5. In other words, the sound absorption material 30 has a basic shape substantially identical to the shape of the fender cover body 21 as illustrated in FIG. 3.

The sound absorption material 30 has a top wall 30a that corresponds to the top plate 21a and a vertical wall 30b that corresponds to the vertical plate 21b. Further, the top wall 30a has a longitudinal pair of notches 30c to avoid interference with the step parts 21d of the fender cover body 21.

These top wall 30a and vertical wall 30b of the sound absorption material 30 have their surfaces respectively in surface contact with the surfaces of the top plate 21a and the vertical plate 21b of the fender cover body 21.

Further, the top wall 30a and the vertical wall 30b are fixed to the top plate 21a and the welding areas 23 through thermal welding while they are in surface contact.

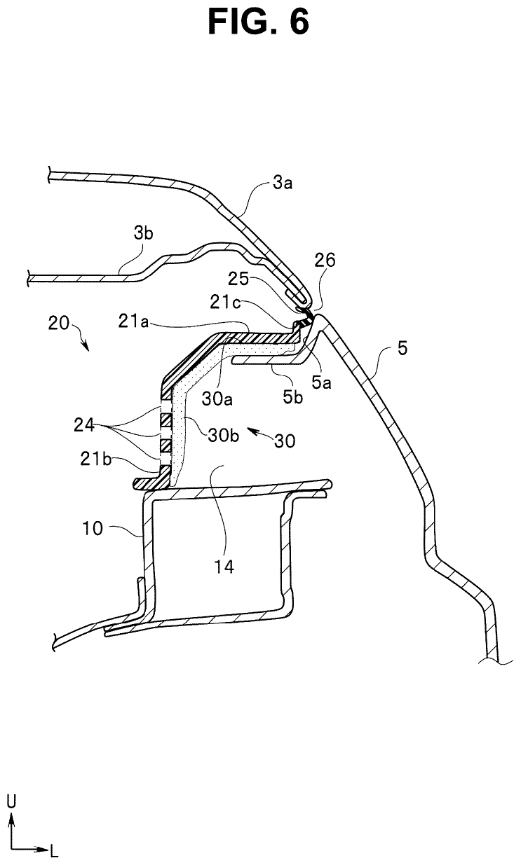

Thereby, the surface of the vertical wall 30b is fixed along the surface of the area having the holes 24 in the vertical plate 21b. Also, attaching the fender cover body 21 to the front fender panel 5 causes the top wall 30a to be held between the top plate 21a and the flange 5b (see FIG. 6).

Each of the notches 30c serves also as an alignment member for attaching the sound absorption material 30 to the fender cover body 21. Accordingly, each of the notches 30c is formed to have a dimension slightly greater than that of each of the step part 21d. This enables each of the notches 30c to be adequately aligned with its corresponding one of the step parts 21d without interference.

Thus fixed sound absorption material 30 can absorb noise N that has come from the engine room 4 through the holes 24 (see FIG. 7).

In order to adequately absorb the noise N from the engine room 4, conditions such as for example the thickness of the sound absorption material 30, the density of the sound absorption material 30, the size of the holes 24, and the pitch of the holes 24 are beforehand obtained through experiments, simulations, etc.

As described above, in the present embodiment, the sound absorption material 30 is equivalent to a specific example of a sound insulation material.

According to this embodiment, a vehicle fender cover structure is disposed to cover the gap 14 above the vehicle body frame member on a vehicle-widthwise outer side in an engine room The vehicle fender cover structure includes a fender cover body 21 including a vertical plate 21b formed to cover the gap 14 from a vehicle-widthwise inner side, and a top plate 21a projecting from an upper end of the vertical plate 21b toward a vehicle-widthwise outer side; a sound insulation material 30 that is provided along a surface of the vertical plate 21b and that is formed to prevent noise from being released from the engine room 4 to outside of a vehicle; and a seal 25 that is provided on the top plate 21a, that is brought into elastic contact with a vehicle-widthwise inner side of an upper end part of an exterior member, and that is formed to block a current of air gushing to outside of the vehicle from the engine room 4. The fender cover body 21 is formed of a material that is harder than the sound insulation material 30. This configuration can improve sound insulation performance for noise released to the outside of the vehicle from the engine room 4, while securing the airtightness at the side portions that use seals 25 in the engine room 4.

Specifically, the sound absorption material 30 is provided along the surface of the fender cover body 21 that covers the gap 14 above the apron upper member 10.

This enables the fender cover 20 to suppress, with the sound absorption material 30, noise released from the engine room 4 toward the front fender panel 5. Therefore, the fender cover 20 can achieve high sound insulation performance for noise released to the outside of the vehicle from the engine room 4.

Also, the top plate 21a has the seal 25 that is brought into elastic contact with the vehicle-widthwise inner side of the upper end part of the front fender panel 5, thereby blocking a current of air gushing from the engine room 4 to the outside of the vehicle. The top plate 21a having the seal is formed of a material that is harder than the sound absorption material 30.

These enable the fender cover 20 to adequately block, with the seal 25, the current of air A gushing to the outside of the vehicle through the gap 26 during travel, as illustrated in FIG. 7. In other words, the seal 25 is supported on the top plate 21a that is harder than the sound absorption material 30. The top plate 21a belongs to the fender cover body 21. A supporting structure like this can bring the seal 25 into pressure contact with the front fender panel 5 and the engine hood 3 more adequately than a structure where the seal 25 is supported on for example the top wall 30a of the sound absorption material 30.

Thereby, the seal 25 adequately blocks the current of air A gushing to the outside of the vehicle through the gap 26 during travel. The fender cover 20 can thereby suppress turbulence in the wind caused by the traveling vehicle 1, leading to improved aerodynamic performance.

For the above configuration, the fender cover body 21 may be formed of a synthetic resin material such as a polypropylene (PP) material etc. such that the fender cover body 21 is a member that is harder than the sound absorption material 30 but can collapse under a collision load more than or equal to a prescribed value. This enables the fender cover 20 to be deformed (collapsed) together with the front fender panel 5 when the head etc. of a pedestrian hits the front fender panel 5 in the event of collision etc. of the vehicle 1. Thereby, the fender cover 20 can secure the safeness of a pedestrian in the event of collision of the vehicle 1.

In addition, the vertical plate 21b further has the holes 24 at positions opposite to the sound absorption material 30. With these holes 24, the vertical plate 21b can transmit the noise N from the engine room 4 to the sound absorption material 30 without blocking the noise N, as illustrated in FIG. 7.

Specifically, the sound absorption material 30 is provided at least in an area having the holes 24 along a surface on an outer side of the engine room 4. This enables the sound absorption material 30 to achieve a higher sound absorption effect for the noise N transmitted from the engine room 4 than when the vertical plate 21b does not have holes 24. Therefore, the fender cover 20 can achieve higher sound absorption performance for the noise N released from the engine room 4 to the outside of the vehicle.

In the above configuration, the holes 24 serve also as a fragile part of the vertical plate 21b. The holes 24 thus serve as the starting point of the collapse (deformation) for the vertical plate 21b, which concentratedly receives a collision load when a collision load more than or equal to a prescribed value is applied from above the fender cover 20. This enables the fender cover 20 to increase the absorption of collision energy when a collision load more than or equal to a prescribed value is applied from the above.

The vertical plate 21b, which can be deformed starting from the holes 24, can also reduce the reaction force accompanying the pressure contact between the engine hood 3 and the seal 25 occurring when the opening 7 is closed by the engine hood 3. This enables the fender cover 20 to suppress the resistance due to the reaction force generated when the opening 7 is closed by the engine hood 3. Thereby, the fender cover 20 having the seal 25 can secure sufficient closure of the engine hood 3.

Also, the fender cover body 21, formed of a synthetic resin material such as a polypropylene (PP) material etc., can fix the sound absorption material 30, formed of a non-woven fabric etc., in surface contact with the fender cover body 21 through thermal welding. Thereby, the fender cover 20 does not require riveting etc. for fixing the sound absorption material 30. This enables the fender cover 20 to fix the sound absorption material 30 to the fender cover body 21 without affecting the appearance.

Also, the top plate 21a has the longitudinal pair of step parts 21d. The projection of each of the step parts 21d is designed to have a dimension equivalent to the thickness of the sound absorption material 30. This enables the top wall 30a of the sound absorption material 30 to be held between the top plate 21a and the flange 5b. The fender cover 20 can thereby more adequately fix the sound absorption material 30 existing between the top plate 21a and the flange 5b, when the fender cover body 21 is attached to the front fender panel 5.

While explanations have been given using the sound absorption material 30 as an example of a sound insulation material in the present embodiment, it is also possible to provide a sound insulation material such as a noise blocking material etc. along the fender cover body 21.

According to a vehicle fender cover structure of an embodiment of the present invention, it is possible to improve sound insulation performance for noise released to the outside of the vehicle from the engine room, while securing the airtightness at the side portions that use seals in the engine room.

The engine room of an automobile, etc. has a lateral pair of apron upper members as vehicle body frame members. The apron upper members exist on vehicle-widthwise outer sides in the engine room and extend in the longitudinal direction of the vehicle body. Each of the apron upper members has a front fender panel above it via a bracket in order to protect pedestrians.

This structure results in a gap existing between the upper surface of the apron upper member and the attachment part of the front fender panel attached to the bracket, and this gap is equivalent to the height of the bracket.

In general, the engine room has fender covers at side portions of the engine room in order to cover this gap from the vehicle-widthwise inner sides.

A fender cover (fender protector) has, for example, a generally L-shaped section as described by Japanese Unexamined Patent Application Publication (JP-A) No. 2009-161141.

Further, a fender cover has a seal on its upper surface as described by JP-A No. 2009-161141. This seal is brought into elastic contact with the side peripheral portions of the engine hood and can thereby suppress a current of air gushing from the engine room to the outside of the vehicle during travel. This suppression, by a seal, of a current of air to the outside of a vehicle improves its aerodynamic performance.

The fender cover, which covers the gap at the side portions of the engine room, suppresses the transmission of noise from the engine room to the front fender panel. The fender cover thereby contributes also to the suppression of noise released to the outside of the vehicle via the front fender panel. It would thus be an option to for example form a fender cover out of a sound insulation material etc. in order to improve the sound insulation performance.

Forming a fender cover out of a sound insulation material etc. results in a fender cover with reduced rigidity, sometimes making it difficult to provide the fender cover with a seal. In that case, there is a possibility that airtightness cannot be secured at the side portions of the engine room by the use of a seal, thereby allowing a current of air gushing to the outside of the vehicle to degrade the aerodynamic performance.

A vehicle fender cover structure according to an embodiment of the present invention improves sound insulation performance for noise released to the outside of the vehicle from the engine room, while securing the airtightness at the side portions that use seals in the engine room.

An aspect of the present invention provides a vehicle fender cover structure disposed to cover a gap above a vehicle body frame member of a vehicle on an outer side of an engine room in a vehicle widthwise direction of the vehicle. The vehicle fender cover structure includes a fender cover body including a vertical plate that covers the gap from an inner side in the vehicle widthwise direction, and a top plate projecting from an upper end of the vertical plate outward in the vehicle widthwise direction; a sound insulation material provided along a surface of the vertical plate, the sound insulation material being formed to prevent noise from being released from the engine room to an outside of the vehicle; and a seal provided on the top plate, the seal being brought into elastic contact with an inner side in the vehicle widthwise direction of an upper end part of an exterior member of the vehicle, the seal being formed to block a current of air gushing to the outside of the vehicle from the engine room. A hardness of a material of the fender cover body is greater than a hardness of a material of the sound insulation material.

Obviously, numerous modifications and variations of the present invention are possible in light of the above teachings. It is therefore to be understood that within the scope of the appended claims, the invention may be practiced otherwise than as specifically described herein.

1. A vehicle fender cover structure, comprising:
a fender cover body comprising a vertical plate;
a sound insulation material positioned along a surface of the vertical plate and configured to prevent noise from being released from an engine room of a vehicle to an outside of the vehicle; and
a seal positioned on a top plate projecting from an upper end of the vertical plate outward in a vehicle widthwise direction and configured to be brought into elastic contact with an inner side in the vehicle widthwise direction of an upper end part of an exterior member of the vehicle and block a current of air gushing to the outside of the vehicle from the engine room,
wherein the vertical plate of the fender cover body is configured to cover the top plate and a gap above a vehicle body frame member of the vehicle on an outer side of the engine room in the vehicle widthwise direction from an inner side in the vehicle widthwise direction, and a hardness of a material of the fender cover body is greater than a hardness of a material of the sound insulation material.

2. The vehicle fender cover structure according to claim 1, wherein the vertical plate has holes formed at positions opposite to the sound insulation material, and the sound insulation material is a sound absorption material that absorbs the noise from the engine room.

3. The vehicle fender cover structure according to claim 2, wherein the sound absorption material is positioned at least in an area having the holes along a surface on an outer side of the engine room.
